(19) United States
(12) Patent Application Publication
(10) Pub. No.: US 2026/0120319 A1
(43) Pub. Date: Apr. 30, 2026

(54) SYSTEM AND METHOD FOR OPTIMIZING OBJECT DETECTION

(71) Applicant: Samsung Electronics Co., Ltd., Gyeonggi-do (KR)

(72) Inventors: Yanlin ZHOU, San Diego, CA (US); Mostafa EL-KHAMY, San Diego, CA (US)

(21) Appl. No.: 19/352,254

(22) Filed: Oct. 7, 2025

Related U.S. Application Data
(60) Provisional application No. 63/713,776, filed on Oct. 30, 2024.

(51) Int. Cl. G06T 7/73; G06T 7/11; G06T 7/90

(52) U.S. Cl. CPC G06T 7/75; G06T 7/11; G06T 7/90; G06T 2207/10024; G06T 2207/20081; G06T 2207/20084; G06T 2207/20132; G06T 2207/20221; G06T 2207/30201

(57) ABSTRACT

A system and a method are disclosed for receiving an input image; dividing the input image into two or more regions; generating an augmented image based on the two or more regions, wherein generating the augmented image includes at least one of applying mixup to blend pixel values from an overlapping portion of the two or more regions, or performing channel sampling to integrate red green blue (RGB) information from the overlapping portion of the two or more regions; detecting an object within a bounding box based on the blended pixel values or the integrated RGB information; and performing a function based on the detected object.

### CROSS-REFERENCE TO RELATED APPLICATION

This application claims the priority benefit under 35 U.S.C. § 119(e) of U.S. Provisional Application No. 63/713,776, filed on Oct. 30, 2024, the entire contents of which are incorporated herein by reference.

### TECHNICAL FIELD

The disclosure generally relates to object detection technologies in the field of computer vision and human-computer interaction. More particularly, the subject matter disclosed herein relates to improvements to edge computing-based systems for detecting and localizing objects with identifiable features, such as hands, faces, limbs, or similar regions of interest, through data augmentation methods, optimized training strategies, and enhanced neural network architectures.

### SUMMARY

Hand and object detection systems may be widely used in computer vision applications, including gesture recognition interfaces, augmented reality (AR), and virtual reality (VR) environments. These systems may rely on machine learning models to identify and localize specific features, such as hands, body parts, physical objects, or other objects of interest, by generating bounding boxes or masks. When deployed on edge computing devices, such as smartphones and head-mounted displays (HMDs), it may become useful for these systems to balance detection accuracy, computational efficiency, and real-time performance, which may be a complex and computer-intensive task for resource constrained devices.

To solve this problem, some solutions use standard methods, such as basic (“vanilla”) MOSAIC data augmentation techniques, fixed cropping strategies, and neural network architectures designed for generalized object detection. While effective in some cases, these methods can have difficulty handling dynamic conditions, including varying lighting, complex backgrounds, and partial occlusions (e.g., when an object of interest is partially blocked by another object). Furthermore, edge devices may be constrained by limited processing power and memory, which can reduce the feasibility of using computationally intensive models.

One issue with the above approaches is that training techniques may not generate sufficient variability in the training data, which can limit the model's ability to generalize across diverse conditions. For example, vanilla MOSAIC data augmentation may rely on rigid, non-overlapping layouts, which do not fully capture the diversity needed for robust detection. Similarly, cropping methods used to preprocess training images may not focus on the most relevant regions, reducing the model's ability to extract meaningful features. Neural network models often underutilize intermediate features between branches, which can lead to suboptimal performance in detection tasks.

To overcome these issues, systems and methods are described herein for improving the detection of objects, including hands and other features, on edge devices. The systems may enhance MOSAIC data augmentation by introducing flexible and overlapping image layouts, where cell shapes are dynamic and pixel values are blended using mixup techniques. Channel sampling strategies may also be applied to incorporate information from multiple images without significantly increasing computational costs. Additionally, the described methods may employ focused cropping, where a pose estimation model (also referred to as a “human pose estimation model”) selectively focuses on regions of interest, such as hands, elbows, or similar features, while excluding unrelated elements like the head or background. This preprocessing strategy improves the representation of targeted features within the training data.

The system may further include the use of weighted loss strategies for object regression, combining box localization losses with intersection over union (IOU) losses, such as complete IOU (CIOU), distance IOU (DIOU) or generalized IOU (GIOU). The weights applied to these losses may be treated as hyperparameters, allowing the optimization process to adapt to the detection task. Additionally, enhancements to neural network architectures, such as SpaghettiNet, may incorporate intermediate feature sharing between early and later branches. By concatenating features extracted at different stages of the network and reshaping them for further processing, the system may improve the utilization of available information, enhancing detection accuracy and efficiency.

The above approaches may improve on previous methods because they address challenges related to data variability, feature extraction, and computational efficiency. By refining data augmentation, optimizing preprocessing techniques, and enhancing neural network architectures, the systems and methods described herein may provide reliable and efficient object detection that can operate on resource-constrained edge devices. These improvements may enable the detection of hands, body parts, physical objects, or similar features across a range of conditions, supporting real-time performance in AR, VR, and gesture-based interaction applications.

According to an aspect of the disclosure, a method includes receiving an input image; dividing the input image into two or more regions; generating an augmented image based on the two or more regions, wherein generating the augmented image includes at least one of applying mixup to blend pixel values from an overlapping portion of the two or more regions, or performing channel sampling to integrate red green blue (RGB) information from the overlapping portion of the two or more regions; detecting an object within a bounding box based on the blended pixel values or the integrated RGB information; and performing a function based on the detected object.

According to another aspect of the disclosure, an apparatus includes a processor and a memory coupled to the processor. The processor is configured to receive an input image; divide the input image into two or more regions; generate an augmented image based on the two or more regions, wherein generating the augmented image includes at least one of applying mixup to blend pixel values from an overlapping portion of the two or more regions, or performing channel sampling to integrate RGB information from the overlapping portion of the two or more regions; detect an object within a bounding box based on the blended pixel values or the integrated RGB information; and perform a function based on the detected object.

According to another aspect of the disclosure, a method includes receiving an input image; processing the input image through a classification branch and a regression branch, the classification branch and the regression branch each comprising an early stage and a late stage; generating a first early feature map from the early stage of the classification branch; generating a second early feature map from the early stage of the regression branch; providing the first early feature map to the late stage of the regression branch; providing the second early feature map to the late stage of the classification branch; processing the first and second early feature maps to generate an output; detecting an object based on the output; and performing a function based on the detected object.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating an augmented image generated using an enhanced MOSAIC method, according to an embodiment;

FIG. 2 is a diagram illustrating an augmented image generated using an enhanced MOSAIC method, according to an embodiment;

FIG. 3 is a representation of an input image illustrating a raw visual input before preprocessing, according to an embodiment;

FIG. 4 is a representation of an input image processed using a pose estimation model, according to an embodiment;

FIG. 5 is an illustration of a pose model index that identifies the body points detected by the pose estimation model, according to an embodiment;

FIG. 6 is a representation of a cropped image that isolates the hand region based on the points identified by the pose estimation model, according to an embodiment;

FIG. 7 is a block diagram of a neural network architecture illustrating intermediate feature sharing across classification and regression branches, according to an embodiment;

FIG. 8A is a block diagram illustrating training an object detection model, according to an embodiment;

FIG. 8B is a flowchart illustrating a method for optimizing object detection, according to an embodiment;

FIG. 8C is a flowchart illustrating a method for optimizing object detection, according to an embodiment;

FIG. 9 is a block diagram of an electronic device in a network, according to an embodiment; and

FIG. 10 is a block diagram illustrating a system including a user equipment (UE) and a network node, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Object” as used herein refers to any entity, feature, or region of interest within an image that the system is designed to detect or localize. Some examples of “objects” may be hands, body parts, or other physical entities visible in an image.

“Data augmentation” as used herein refers to techniques used to modify and expand training datasets by creating variations of existing data to improve the performance and generalization of machine learning models. Some examples of “data augmentation” may be MOSAIC, mixup, cropping, scaling, rotating, and flipping images.

“Mixup” as used herein refers to a data augmentation method that blends pixel values from overlapping regions of two or more images using a linear combination. The blending may be controlled by a weighting factor sampled from a probability distribution. Some examples of “mixup” may include blending RGB values from two overlapping images to create a composite region or combining pixel values to produce smoother transitions between training samples.

“Channel sampling” as used herein refers to the process of selecting specific color channels (e.g., red, green, or blue) from multiple images to create a new composite image. This technique is used to enhance variability in training data while optimizing computational efficiency. Some examples of “channel sampling” may be using the red channel from one image and the green and blue channels from another, or combining channels from three different images into a single composite region.

“Bounding box” as used herein refers to a rectangular region defined by coordinates that enclose an object of interest within an image. Some examples of “bounding boxes” may be those used to outline detected hands, physical objects, or other features for classification, localization, or tracking purposes.

“Performing a function” as used herein refers to executing a task or operation based on the detected object or its associated data. Some examples of “performing a function” may be triggering a user interface action, recognizing a gesture for controlling an application, logging a detected object, or sending object detection results to another system or device.

“Region” as used herein refers to a portion of an image that has been divided or segmented for purposes of augmentation or analysis. Some examples of “regions” may be rectangular sub-sections of an image arranged in a grid, non-square sub-sections such as 1×2 or 2×1 areas, irregular or free-form sub-sections, or single-pixel level portions when fine-grained operations are applied.

“Cell” as used herein refers to a subdivision of an image space within a grid-based augmentation process, such as MOSAIC. Some examples of “cells” may be a 1×1 square unit of a grid, a rectangular unit such as 1×2 or 2×1, or an irregular polygonal unit defined by overlap between multiple images. A “cell” may not be limited to a single pixel, but may encompass one or more pixels grouped together to form a distinct subregion of the augmented image.

“Feature map” as used herein refers to an intermediate representation of an image generated by a neural network layer. A feature map is a multi-dimensional array that encodes features detected in the input image or in a portion of the image. Some examples of “feature maps” include arrays that represent low-level properties such as edges, contours, or textures obtained from regions or overlapping regions of the input, and arrays that represent high-level properties such as the shape of a hand, the position of an elbow, or bounding box coordinates. In some embodiments, feature maps may be generated from regions defined by data augmentation, from overlapping regions that combine pixel information from multiple images, or from regions of interest identified using a pose model index (e.g., nodes corresponding to hands or elbows).

“Concatenation” as used herein refers to an operation that joins two or more arrays along a specified dimension to produce a single combined array. Some examples of “concatenation” may be joining a feature map from a classification branch with a feature map from a regression branch along a channel dimension to form a joint representation for subsequent processing.

“Body” as used herein refers to an articulated structure comprising multiple linked parts about one or more joints or hinges. Some examples of “body” may be a human body, an animal body, a robotic manipulator, or a tool assembly with articulated segments (e.g., a gripper and forearm).

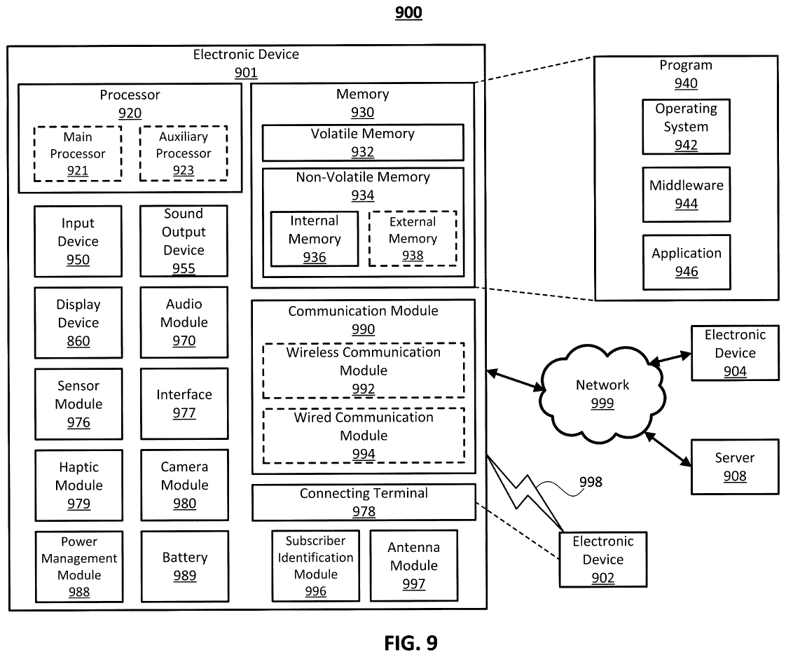

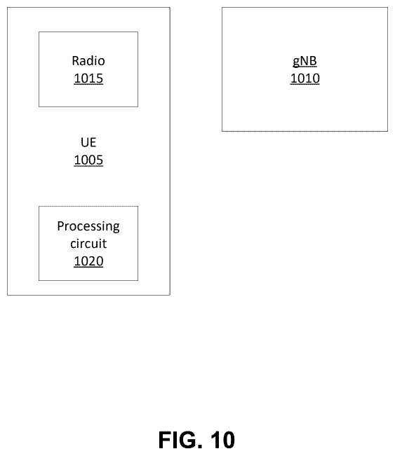

“Edge device” as used herein refers to a computing device that performs processing locally at the periphery of a network, rather than relying on a remote cloud server. Some examples of “edge device” may be the electronic device 901 of FIG. 9 (e.g., a smartphone or tablet), or the UE 1005 of FIG. 10 in communication with a network node 1010. In various embodiments, an edge device may include components such as a processor (e.g., 920), a memory (e.g., 830), and a camera module (e.g., 980), and may execute the methods described herein for detecting objects, generating augmented images, and/or performing functions based on detected objects.

The present disclosure describes systems and methods for detecting and localizing objects of interest, such as hands, body parts, physical objects, or similar features, in visual inputs using various machine learning models. The described systems may be designed to operate efficiently on edge devices, such as smartphones, AR headsets, and VR devices, where computational resources may be limited. To improve performance in real-world environments, one or more solutions disclosed herein may focus on enhanced data augmentation techniques, targeted preprocessing strategies, and optimized neural network architectures that address challenges, including varying backgrounds, lighting conditions, occlusions, and limited processing power.

One aspect of the disclosure may improve data augmentation through a refined version of the MOSAIC method. This enhanced MOSAIC method may eliminate the need for fixed grid layouts by introducing flexibility through overlapping regions and dynamic cell shapes. The system may further incorporate mixup techniques to blend image regions and channel sampling to integrate information across multiple images. These enhancements may produce more diverse and information-rich training datasets, which may allow the machine learning model to better generalize across different scenarios. Another aspect may involve focused cropping of visual inputs using a pose estimation model, where the system may identify areas or regions of interest, such as hands or other relevant features, and selectively remove extraneous details. This preprocessing step may ensure that the model learns more meaningful representations without interference from unrelated regions.

To further improve detection accuracy, various embodiments may introduce weighted loss strategies during the training process. By combining localization loss with IOU-based losses, the system may achieve a balanced and optimized training process that emphasizes accuracy and/or computational efficiency. Additionally, some embodiments may enhance neural network architectures by introducing intermediate feature sharing, where features extracted in earlier layers are combined with later layers for improved detection performance. These systems and methods may collectively enable reliable, efficient object detection suitable for edge devices.

According to an embodiment, the present disclosure describes an enhanced MOSAIC data augmentation method that improves the generation of training datasets for object detection models.

Typically, in MOSAIC methods, training images may be arranged in a fixed (e.g., 2×2 or 3×3) grid layout, where each image occupies a separate, non-overlapping cell of equal size (e.g., 1×1). While effective in generating composite images, the rigid layout limits the variability of the resulting datasets and does not allow for overlapping regions or dynamic cell configurations. Such limitations can reduce the ability of object detection models to generalize across real-world variations, including dynamic backgrounds, lighting changes, and occlusions. In contrast, the present disclosure may support variable cell shapes, where the cells may take forms such as 1×2, 2×1, 2×2, or other irregular divisions, thereby permitting overlap and flexible arrangement of image regions.

To address these shortcomings, the present disclosure may provide an enhanced MOSAIC method that forms augmented images from two or more regions that may overlap, with variable cell shapes (e.g., 1×2, 2×1, 2×2, or irregular). Within an overlapping region, pixel values may be blended by mixup or composed by channel sampling; when the augmented image is processed, the blended portions may yield feature maps reflecting contributions from multiple source images.

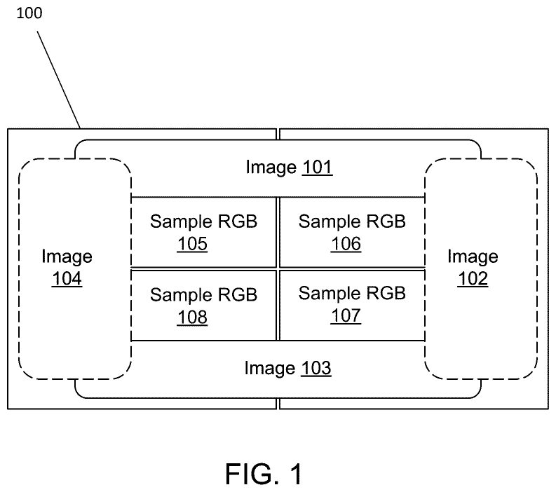

FIG. 1 is a diagram illustrating an augmented image generated using an enhanced MOSAIC method, according to an embodiment.

Referring to FIG. 1, the augmented image 100 may be composed of image 101, image 102, image 103, and image 104, arranged in a dynamic configuration. Cells within a grid in the augmented image 100 may take on flexible shapes, such as 1×2, 2×1, or 2×2. This may allow parts of multiple images to overlap within the same region of the augmented image 100.

The overlapping regions may be processed using a mixup technique, which may blend RGB pixel values from two or more images. For example, FIG. 1 may illustrate how RGB values are sampled and blended from overlapping image pairs, such as a sample 105 from image 101 and image 104, a sample 106 from image 101 and image 102, a sample 107 from image 102 and image 103, and a sample 108 from image 103 and image 104. The mixup technique may apply a linear combination of pixel values based on a factor λ, which may be sampled from a beta distribution within the range [0, 1]. The resulting pixel value X_{new}, may be computed as Equation 1:

$${X}_{n e w} = λ * {X}_{1} + ( 1 - λ ) * {X}_{2} \qquad Equation 1$$

where X₁ and X₂ are the RGB values of two overlapping images, and A determines the weighting between them. In some embodiments, A may be selected randomly for each pair of overlapping images, thereby introducing stochastic variability into the training process. In other embodiments, A may be fixed or adjusted dynamically during training to bias the blending toward one image (e.g., when A approaches 0 or 1) or to enforce equal contributions (e.g., when A is 0.5). This flexibility in determining A may allow the system to control the degree of blending, which may generate smooth transitions between overlapping regions.

In addition to, or alternatively to, mixup, the system may incorporate channel sampling to further optimize the augmentation process. Channel sampling may selectively integrate RGB information from two or more images within overlapping regions, reducing the computational overhead typically associated with mixup while maintaining effective information integration.

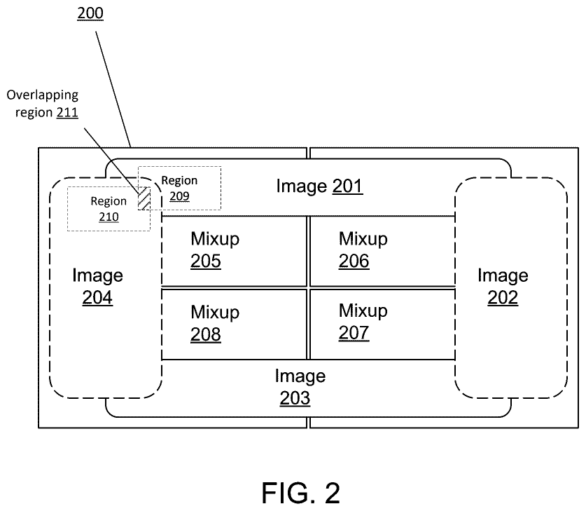

FIG. 2 is a diagram illustrating an augmented image generated using an enhanced MOSAIC method, according to an embodiment.

Referring to FIG. 2, the augmented image 200 may include images 201, 202, 203, and 204, and may be formed from overlapping in which RGB data is sampled and blended from image pairs, such as mixup 205 from image 201 and image 204, mixup 206 from image 201 and image 202, mixup 207 from image 202 and image 203, and mixup 208 from image 203 and image 204. As illustrated in FIG. 2, a “region” may refer to a subdivision of an image, such as region 209 defined within image 201. An “overlapping region” may occur when a region of one image extends into a region of another image, such as overlapping region 211 where region 209 of image 201 overlaps with region 210 of image 204. An “overlap” may refer to an overlapping region. One or more specific pixels within the overlapping region may be blended or sampled during augmentation, which may contribute pixel information to mixup 205. When such augmented images are processed by a neural network, these overlapping regions may be represented as feature maps, which may be multi-dimensional arrays encoding textures, contours, and spatial cues from the blended portions of the input.

The combination of dynamic cell shapes, overlapping regions, mixup blending, and channel sampling may improve the quality and variability of the training data in the enhanced MOSIAC method disclosed herein. In this approach, the enhanced MOSAIC approach may allow models to learn more robust feature representations, which may improve their performance in detecting objects, such as hands, body parts, or physical objects, across a range of operating conditions.

To improve the quality of training datasets for edge-based detection models, various embodiments of the present disclosure may provide a focused cropping method around regions of interest, such as hands and elbows. This method may apply a pose estimation model to identify and localize body features within input images. By preprocessing the training data to exclude unrelated regions, such as the head and facial features, the system may enhance the ability of models to focus on the relevant features, which may lead to better performance in hand and gesture detection tasks.

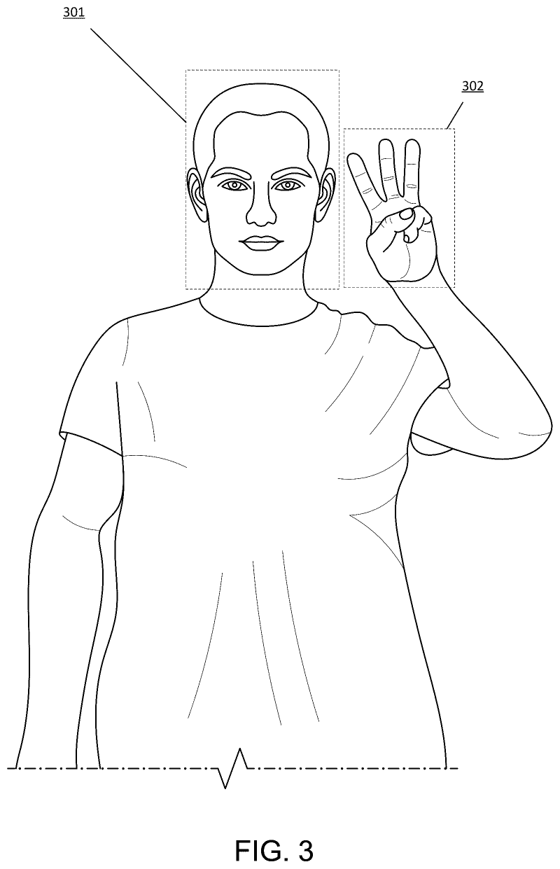

FIG. 3 is a representation of an input image illustrating a raw visual input before preprocessing, according to an embodiment.

Referring to FIG. 3, a person may be standing against a background while holding up their hand. In the raw image, irrelevant features such as the facial region 301, may be present. Without preprocessing, these additional elements may interfere with the model's learning process, reducing its ability to identify and localize objects such as hands 302 effectively.

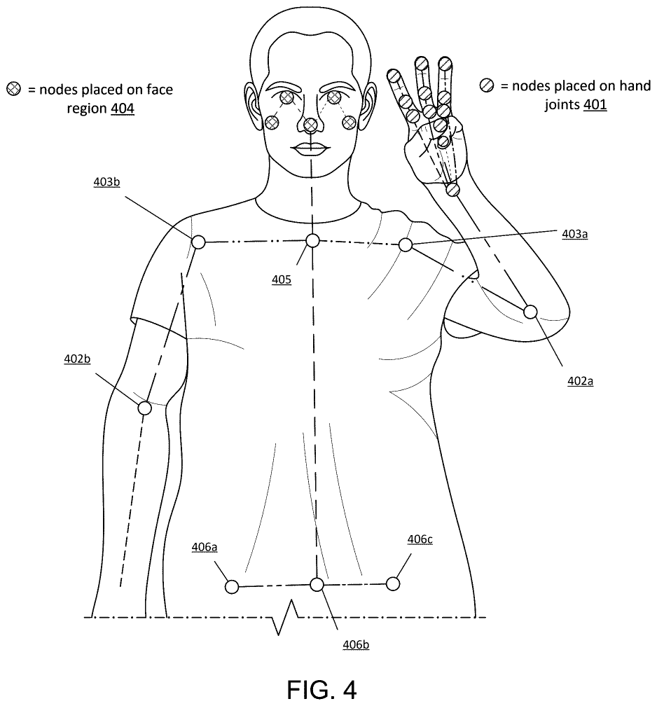

FIG. 4 is a representation of an input image processed using a pose estimation model, according to an embodiment.

Referring to FIG. 4, the pose estimation model may detect key points along a person's body, represented as a series of lines and nodes overlaid on the image of FIG. 3. For instance, nodes may be placed on the hand joints 401, elbows 402a and 402b, shoulders 403a and 403b, and other body locations (e.g., face region 404, chest 405, and waist 406a, 406b, and 406c). This process may allow the system to determine the exact positions of hands and elbows within the input image. The detected points may then be used to guide the cropping process, focusing the area of interest on objects, such as the hands and elbows, while excluding extraneous regions, such as the head and other body parts.

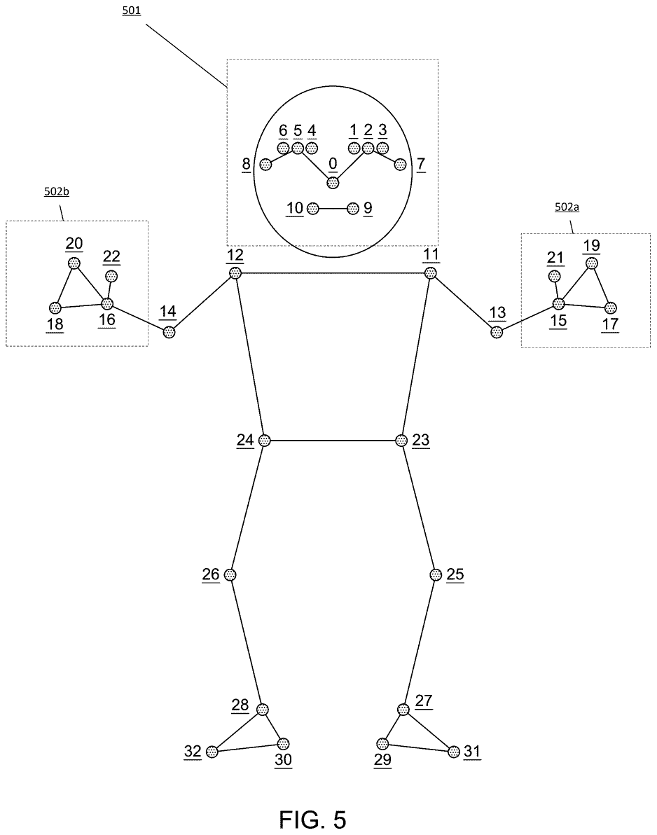

FIG. 5 is an illustration of a pose model index that identifies the body points detected by the pose estimation model, according to an embodiment.

Referring to FIG. 5, a pose model index is illustrated, which may represent a body as a set of indexed nodes labeled 0-32 corresponding to anatomical indexes, such as wrists, elbows, and shoulders. The node index may provide a consistent frame of reference across images: nodes may define regions of interest for downstream operations (e.g., hand and elbow) and exclude data outside those regions. Feature maps derived from node-defined regions may therefore represent the contours and shapes associated with the indicated landmarks (body parts) while omitting background pixels. Each node may correspond to a specific part of the body, such as the fingertips (e.g., nodes 17-20), wrists (e.g., nodes 15-16 and 21-22), elbows (e.g., nodes 13-14), and shoulders (e.g., nodes 11-12). The node index may ensure consistency in identifying and referencing points across different images. For example, nodes 15-22 may represent the hand and wrist joints which are included in hand regions 502a-502b, nodes 13-14 may represent the elbows, and nodes 0-10 may represent the facial region 501.

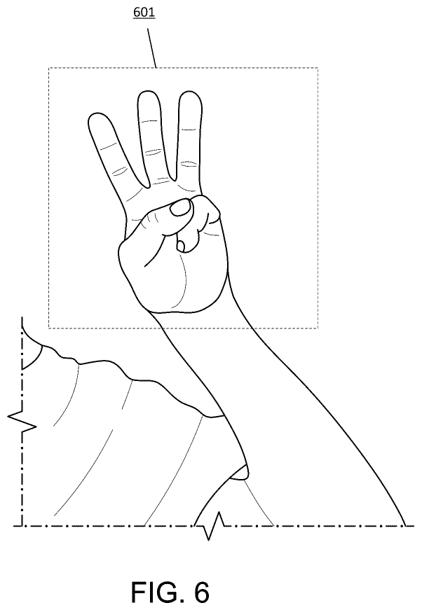

FIG. 6 is a representation of a cropped image that isolates the hand region based on the points identified by the pose estimation model, according to an embodiment.

Referring to FIG. 6, by isolating the hand region 601, the method may remove pixel data outside the region of interest 601 (e.g., facial features or background may be removed) and retain only the pixels within the node-defined hand and elbow region. As a result, the network may form feature maps that are derived from the retained region and do not encode extraneous background content, enabling subsequent analysis to operate directly on the region of interest.

Accordingly, the focus cropping technique may improve the efficiency and accuracy of training models by removing unused data and directing the model's attention to the most relevant features. The integration of a pose estimation model may ensure that the cropping process is adaptable to various input images. This method may be advantageous for resource-constrained edge devices, as it may minimize computational overhead by reducing the size and complexity of the input data.

According to an embodiment, systems and methods for enhancing the performance of object detection models through the use of weighted loss routines during the training process may be provided. These approaches may improve object localization tasks by combining multiple loss functions to improve model accuracy and performance.

One or more of the weighted loss routines may encompass two components: box localization loss and box IOU loss. Box localization losses, such as L1 or L2 loss, may quantify the difference between the coordinates of the predicted bounding box and those of the ground truth. In contrast, box IOU loss may measure the extent of overlap between the predicted and ground truth bounding boxes, directly evaluating how well they coincide. By assigning weights to these losses, determined as hyperparameters, the training process can be finely tuned to balance localization accuracy and overlap optimization.

The IOU loss can be expressed as Equation 2:

$$IOU loss = 1 - IOU \qquad Equation 2$$

where IOU represents the ratio of the intersection area to the union area of the predicted and ground truth bounding boxes. Each of the variants of IOU loss, such as CIOU, DIOU, and GIOU, may follow this same fundamental equation, allowing for flexible integration into the training process. These losses can be applied in addition to the localization loss.

A total regression loss may then be calculated as a weighted combination of the IOU loss and the localization loss, such as L₁, as shown in Equation 3:

$$Loss Regression = α * IOU loss + β * {L}_{1} \qquad Equation 3$$

where α and β are hyperparameters that adjust the relative weight of the IOU loss and the L₁ loss during model training. These values may be selected empirically or adjusted dynamically to tune performance based on training behavior.

One particular variant, the CIOU loss function, may introduce additional terms to improve the convergence and accuracy of bounding box regression. The CIOU loss function may be represented as Equation 4:

$${L}_{CIOU} = 1 - IOU + \frac{{d}^{2}}{{C}^{2}} + α v \qquad Equation 4$$

where, d is the Euclidean distance between the centers of the predicted bounding box and the ground truth bounding box, and C is the diagonal length of the smallest enclosing box that includes both the predicted and ground truth bounding boxes. The term a is a trade-off parameter which determines how much weight is given to an aspect ratio consistency term v relative to the other components of the loss function in Equation 4. α may be defined according to Equation 5:

$$α = \frac{v}{( 1 - IOU ) + v} \qquad Equation 5$$

The parameter v represents the consistency of aspect ratios between the predicted bounding box and the ground truth bounding box and may be expressed according to Equation 6:

$$v = \frac{4}{{π}^{2}} {( arctan \frac{{w}^{gt}}{{h}^{gt}} - arctan \frac{w}{h} )}^{2} \qquad Equation 6$$

where w^{gt} and h^{gt} refer to the width and height of the ground truth bounding box, while w and h represent the width and height of the predicted bounding box. By including a term representative of the aspect ratio (v) and the distance between bounding box centers, the CIOU loss function of Equation 4 (L_{CIOU}) may provide a more refined measure of bounding box alignment, beyond mere spatial overlap.

By incorporating the CIOU loss function into the training process, the system may optimize the spatial overlap between bounding boxes as well as the distance between their centers and the consistency of their aspect ratios. This approach may ensure that the predicted bounding boxes may be accurately aligned with the ground truth bounding boxes, improving regression accuracy.

According to an embodiment, the present disclosure may propose an enhancement to the open-source SpaghettiNet model by incorporating intermediate feature sharing. This modification may improve the performance of the model for tasks such as object detection and regression by utilizing both early and later feature maps during processing.

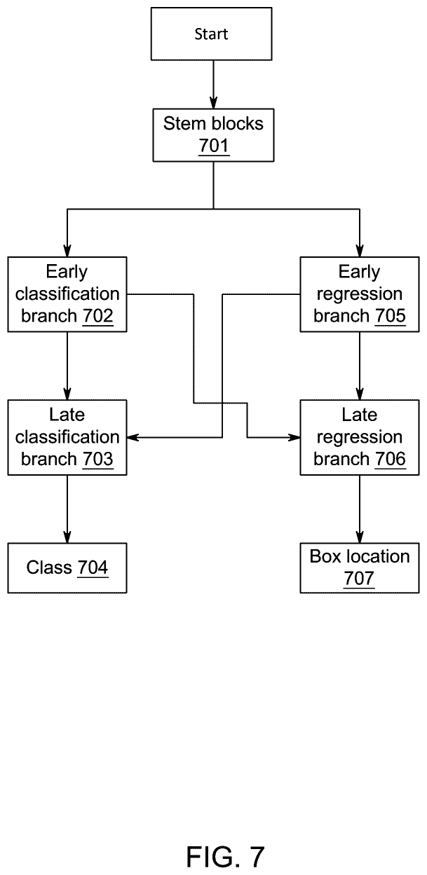

FIG. 7 is a block diagram of a neural network architecture illustrating intermediate feature sharing across classification and regression branches, according to an embodiment.

Referring to FIG. 7, an input image may be processed through stem blocks 701, which may serve as the initial feature extraction stage of the network. The stem blocks 701 may include one or more convolutional layers, fully connected layers, normalization layers, and/or non-linear activation functions. These operations may produce a set of feature maps that may be subsequently forwarded to two separate branches: a classification branch and a regression branch. In some embodiments, when the input image is an augmented image formed from regions and overlapping regions (e.g., as described with respect to MOSAIC, mixup, or channel sampling), the set of feature maps may encode information from those blended portions.

The classification branch may be composed of two sub-blocks: early classification branch 702 and late classification branch 703. The early classification branch 702 may process the set of feature maps output from block 701 and generate classification-oriented feature maps that indicate edges, contours, and/or textures of an image. These features maps may be referred to as a first set of “intermediate feature maps”, and may then be forwarded to the late classification branch 703, which may refine the first set of intermediate feature maps and produce class predictions at output block 704 labeled “Class”.

Parallel to the classification branch, the regression branch includes early regression branch 705 and late regression branch 706. The early regression branch 705 may operate on the feature maps output from block 701 to extract spatial and structural information useful for localizing objects, thereby generating regression-oriented feature maps, which may be referred to as a second set of “intermediate feature maps”, that may indicate a bounding box estimation. This results in bounding box predictions output at block 707 labeled “Box Location”.

To enable cross-branch use of the first and second sets of intermediate feature maps, the present disclosure may provide cross-branch feature sharing between the classification and regression branches. This allows for intermediate feature maps to be shared between branches. In a first direction, a first set of feature maps (early classification feature maps) (from branch 702) may be supplied to the late regression branch 706, enabling the regression pathway to consume classification-oriented information. Conversely, in a second direction, a second set of feature maps (early regression feature maps) (from branch 705) may be supplied to the late classification branch 703, so that classification is based on spatial and structural information. In certain embodiments, the supplied maps may be concatenated along a channel dimension with maps native to the receiving branch to form a combined representation that preserves information from both sources; the combined representation may then be processed by subsequent layers (e.g., convolution, or normalization) within the receiving branch. This bidirectional flow of intermediate feature maps may enable the use of intermediate representations from multiple branches before final outputs are produced.

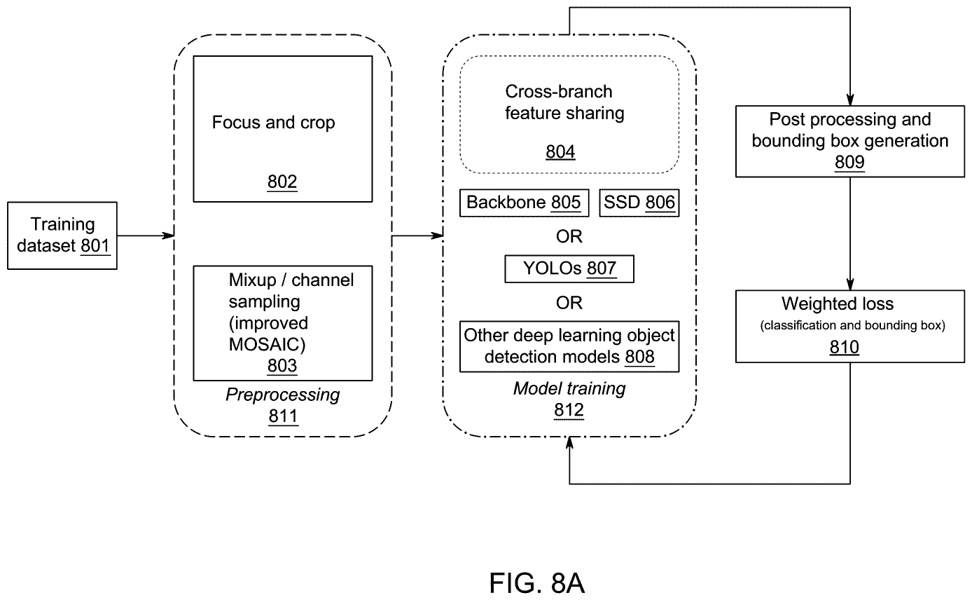

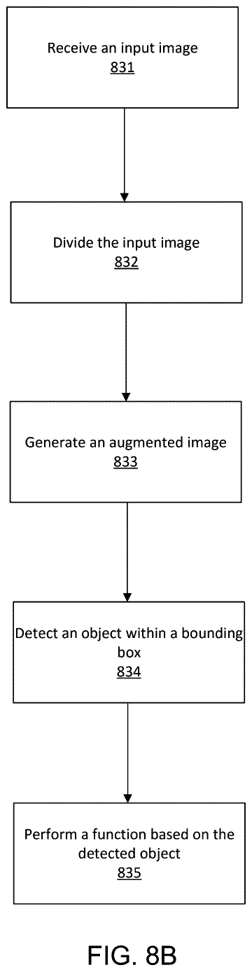

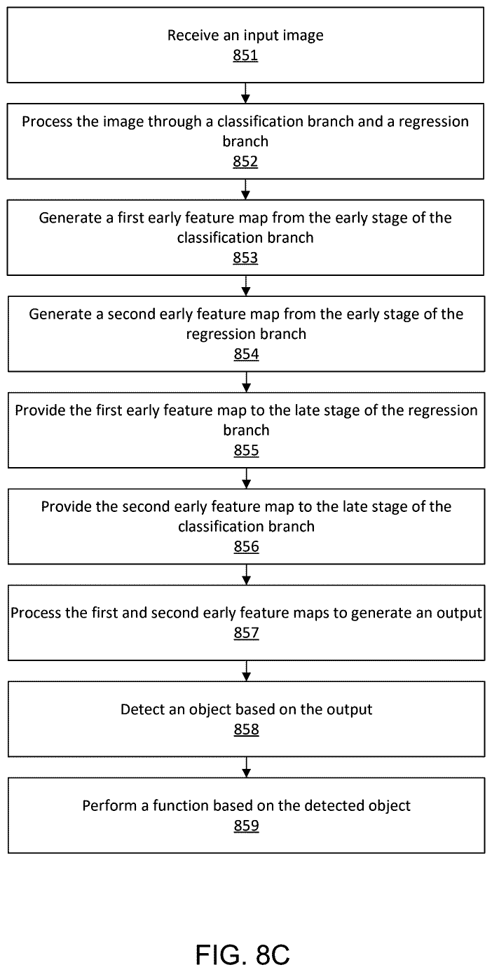

FIG. 8A is a block diagram illustrating training an object detection model, according to an embodiment. The diagram presents a high-level view of how different modules interact during the training pipeline.

The process may begin with a training dataset 801 comprising annotated images containing objects of interest, such as hands or gestures, and, in some embodiments, non-human subjects. The dataset 801 may proceed to a preprocessing stage 811 that includes (i) focus and crop 802 and (ii) mixup/channel sampling 803. At block 802 (“focus and crop”), the system may isolate one or more regions using a pose estimation model. The regions may correspond to selected body areas (e.g., a hand and elbow) or, in non-human embodiments, to articulated components such as an animal limb, a robotic manipulator, or a tool assembly. The module identifies landmarks (e.g., joints) and crops the image accordingly, retaining only pixels within a region of interest and excluding pixels outside the region of interest. In this way, subsequent processing may operate directly on the region of interest rather than on extraneous regions.

Following block 802, block 803 (“mixup/channel sampling”) may generate one or more augmented images from two or more regions that may overlap. Unlike other MOSAIC approaches that partition, for example, each of four input images into non-overlapping grid regions, the method disclosed herein may allow image overlap across regions and combine pixel information through mixup and/or channel sampling. In one embodiment, mixup may apply a weighted linear combination of pixel values within an overlapping region, and channel sampling composes RGB channels by selecting per-channel data from different images. Regions and overlapping regions formed at block 803 may be used to generate feature maps in the network that encode blended semantic and spatial cues (e.g., edges, contours, or textures).

Once preprocessing is complete, the training proceeds to model training at block 812. At block 804, cross-branch feature sharing may be introduced, such that early feature maps from one branch may be supplied to a late stage of the other branch; in certain embodiments, the supplied maps may be concatenated along a channel dimension and then processed by the receiving branch. The model architecture may include a backbone 805, such as ResNet or MobileNet, and may be built upon established object detection frameworks, such as single shot multibox detector (SSD) 806 or you only look once (YOLO) 807. In other embodiments, the approach may be applied to other deep learning object detection models at block 808.

After model training, the system may perform post-processing and bounding box generation at block 809, where final predictions are refined and bounding boxes are generated for detected objects. The loss computation may be handled at block 810, where a weighted loss routine may be applied. This routine may combine a classification loss with a bounding box regression loss (e.g., L₁ loss and IOU-based loss) using learned or predefined weights, allowing the system to fine-tune emphasis between classification confidence and localization precision.

FIG. 8B is a flowchart illustrating a method for optimizing object detection, according to an embodiment.

The steps shown in FIG. 8B may be performed in a different order, in parallel, or with some steps omitted or added. The method may be executed by one or more processors configured to carry out the operations using instructions stored in a memory. The method may be performed on an electronic device such as the device 901 (or “edge device”) of FIG. 9, which may include components such as a processor 920, memory 830, camera module 980, and communication module 990. In other embodiments, the method may be carried out on a UE 1005 of FIG. 10 in communication with a network node 1010.

Referring to FIG. 8B, the method begins at step 831, where an input image may be received. This image may originate from a dataset or an image capture device such as a camera. In step 832, the input image may be divided into two or more regions. These regions may correspond to subdivisions based on a grid, random crops, or other spatial segmentation methods.

In step 833, an augmented image may be generated based on the two or more regions. This generation may include at least one of two augmentation strategies. For example, a mixup process may be applied in step 833 to blend pixel values from overlapping portions of the regions. This may involve linearly combining corresponding RGB pixel values from overlapping areas, enhancing variability and improving generalization. Additionally or alternatively, channel sampling may be performed in step 833 to integrate RGB information from the overlapping portion of the regions. This approach may selectively draw individual color channels from different regions or images to form a composite image.

In step 834, an object may be detected within a bounding box based on the blended pixel values or the integrated RGB information. A machine learning model trained with such augmented images may perform this detection. In step 835, a function may be performed based on the detected object using hardware and/or software resources. This function may include classifying the object using one or more trained classifiers, such as convolutional neural networks (CNNs), decision trees, or support vector machines. The classification result may be used to trigger an application-specific system response, such as activating an alert mechanism, initiating a control command for a robotic actuator, adjusting a graphical user interface (GUI) in augmented reality systems, or selectively storing the identified object data in a memory device. In some embodiments, the function may be carried out by executable instructions on a processor interacting with tangible components including memory units, communication interfaces, sensors, and/or actuators. These hardware-implemented operations may identify the object and modify the physical or graphical state of the device or a connected system. Accordingly, the operations may collectively yield technical improvements to computer vision pipelines, including reduced latency, accuracy of bounding box generation, and real-time responsiveness in computing environments.

FIG. 8C is a flowchart illustrating a method for optimizing object detection, according to an embodiment.

The steps shown in FIG. 8C may be performed in a different order, in parallel, or with some steps omitted or added. The method may be executed by one or more processors configured to carry out the operations using instructions stored in a memory.

Referring to FIG. 8C, at step 851, an input image may be received by a neural network. In step 852, the input image may be processed through a classification branch and a regression branch. Each of these branches may include an early stage and a late stage, structured to extract different levels of semantic and spatial features from the input image.

In step 853, a first early feature map may be generated from the early stage of the classification branch. This early feature map typically may capture fine-grained information useful for classifying object categories. In step 854, a second early feature map may be generated from the early stage of the regression branch, capturing spatial or geometric cues useful for bounding box estimation. Step 854 may be performed in parallel with step 853.

To enable cross-branch feature enrichment, in step 855, the first early feature map (from the classification branch) may be provided to the late stage of the regression branch. Similarly, in step 856, the second early feature map (from the regression branch) may be provided to the late stage of the classification branch. This mutual feature sharing may enable each branch to benefit from complementary information, thereby improving overall detection accuracy.

In step 857, the network may process the received early feature maps by applying one or more transformations within the late stages of each branch to generate a final output. In certain embodiments, a transformation may be a concatenation that joins a classification feature map that encodes contours of a hand region with a regression feature map that encodes bounding-box geometry to generate an output. In step 858, an object may be detected based on this output, utilizing the integrated information from both early and late stages across both branches.

Finally, in step 859, a function may be performed based on the detected object. This function may include classifying the object using one or more trained classifiers, such as CNNs, decision trees, and/or support vector machines. The classification result may be used to trigger an application-specific system response, such as activating an alert mechanism, initiating a control command for a robotic actuator, adjusting a GUI in augmented reality systems, or selectively store the identified object data in a memory device. These operations may involve tangible components such as processors, memory units, communication interfaces, and sensors, and may collectively yield a concrete improvement to computer vision systems and object recognition performance in computing environments.

FIG. 9 is a block diagram of an electronic device in a network, according to an embodiment.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from the electronic device 901, or one or more other components may be added to the electronic device 901. Some of the components may be implemented as a single IC. For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled with the processor 920 and may perform various data processing or computations.

Embodiments disclosed herein make use of the structural components of FIG. 9 to implement advanced object detection and processing methods, particularly for resource-constrained devices, such as smartphones, HMDs, or similar electronic devices. For example, the camera module 980 may capture input images or video streams that serve as the foundation for detecting objects, such as hands, body parts, or other features. These inputs may be divided into regions and/or overlapping regions and processed using the processor 920, which executes machine learning models that integrate enhanced MOSAIC data augmentation, mixup techniques, and channel sampling as described herein. By utilizing the processor's computational resources efficiently, solutions disclosed herein ensure real-time processing of input data, enabling seamless deployment on edge devices without the need for cloud-based resources.

The memory 930 may store the machine learning models, training datasets, and intermediate processing data for executing the object detection routines. Various embodiments may enhance the efficiency of these stored models by introducing intermediate feature sharing mechanisms, such as the concatenation of early and later feature maps within SpaghettiNet. These concatenated outputs may allow semantic and/or spatial cues to be preserved, thereby maximizing the use of the available memory. Additionally, the use of weighted loss functions, which optimize box regression and alignment of overlapping bounding boxes, may further improve the processing capabilities of the processor 920 to achieve better accuracy and performance for real-time object detection applications.

In addition, various embodiments may also use the display device 960 to present outputs to users, such as detected bounding boxes, gesture-based control feedback, or other visual indicators derived from the processed feature maps. By incorporating the system into edge devices, such as smartphones or AR/VR systems immersive user experiences, where hand or object detection is seamlessly integrated into interactive environments, may be supported. Furthermore, the communication module 990 may enable data exchange with external servers 908 or other electronic devices 902/904 over short-range or long-range networks, allowing updates to the stored models or synchronization of detected results.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

FIG. 10 is a block diagram illustrating a system including a UE and a network node, according to an embodiment.

Referring to FIG. 10 a system including a UE 1005 and a network node (gNB) 1010, in communication with each other, is provided. The UE may include a radio 1015 and a processing circuit (or a means for processing) 1020, which may perform various methods disclosed herein, e.g., the method illustrated in FIG. 8. For example, the processing circuit 1020 may receive, via the radio 1015, transmissions from the gNB 1010, and the processing circuit 1020 may transmit, via the radio 1015, signals to the gNB 1010.

The processing circuit 1020 of the UE 1005 may implement one or more aspects of the disclosed object detection techniques, such as generating augmented images with mixup or channel sampling, applying focused cropping to regions of an image, or executing a neural network architecture with cross-branch feature sharing. The UE 1005 may thus perform real-time detection of objects, such as hands or gestures, directly on-device, while the gNB 1010 provides connectivity for updating models, synchronizing detected results, or offloading additional processing when needed.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Additionally or alternatively, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple compact disks (CDs), disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving an input image;
dividing the input image into two or more regions;
generating an augmented image based on the two or more regions, wherein generating the augmented image includes at least one of:
applying mixup to blend pixel values from an overlapping portion of the two or more regions, or
performing channel sampling to integrate red green blue (RGB) information from the overlapping portion of the two or more regions;
detecting an object within a bounding box based on the blended pixel values or the integrated RGB information; and
performing a function based on the detected object.

2. The method of claim 1, wherein dividing the input image into the two or more regions comprises dividing the input image into a grid with variable cell shapes.

3. The method of claim 1, wherein applying the mixup comprises blending the pixel values by linearly combining corresponding RGB values from the overlapped portion of the two or more regions using a weighting factor sampled from a beta distribution.

4. The method of claim 1, wherein generating the augmented image includes both applying the mixup to blend the pixel values and performing the channel sampling to integrate the RGB information from the overlapping portion of the two or more regions.

5. The method of claim 1, further comprising preprocessing the input image using a pose estimation model to identify regions of interest, and
cropping the input image to exclude other regions.

6. The method of claim 5, wherein the pose estimation model identifies points on a body to guide the cropping of the input image.

7. The method of claim 1, wherein detecting the object within the bounding box further comprises training a machine learning model using a weighted loss function, the weighted loss function combining a box localization loss with at least one intersection over union (IOU)-based loss.

8. The method of claim 7, wherein the IOU-based loss comprises at least one of a complete IOU (CIOU), a distance IOU (DIOU), and a generalized IOU (GIOU), and the weighted loss function dynamically adjusts a weight of an aspect ratio consistency term during training.

9. An apparatus comprising:
a processor; and
a memory coupled to the processor,
wherein the processor is configured to:
receive an input image;
divide the input image into two or more regions;
generate an augmented image based on the two or more regions, wherein generating the augmented image includes at least one of:
applying mixup to blend pixel values from an overlapping portion of the two or more regions, or
performing channel sampling to integrate red green blue (RGB) information from the overlapping portion of the two or more regions;
detect an object within a bounding box based on the blended pixel values or the integrated RGB information; and
perform a function based on the detected object.

10. The apparatus of claim 9, wherein dividing the input image into the two or more regions comprises dividing the input image into a grid with variable cell shapes.

11. The apparatus of claim 9, wherein applying the mixup comprises blending the pixel values by linearly combining corresponding RGB values from the overlapped portion of the two or more regions using a weighting factor sampled from a beta distribution.

12. The apparatus of claim 9, wherein generating the augmented image includes both applying the mixup to blend the pixel values and performing the channel sampling to integrate the RGB information from the overlapping portion of the two or more regions.

13. The apparatus of claim 9, wherein the processor is further configured to:
preprocess the input image using a pose estimation model to identify regions of interest, and
crop the input image to exclude other regions.

14. The apparatus of claim 13, wherein the pose estimation model identifies points on a body to guide the cropping of the input image.

15. The apparatus of claim 9, wherein the processor is further configured to train a machine learning model using a weighted loss function, the weighted loss function combining a box localization loss with at least one intersection over union (IOU)-based loss.

16. The apparatus of claim 15, wherein the IOU-based loss comprises at least one of a complete IOU (CIOU), a distance IOU (DIOU), and a generalized IOU (GIOU), and the weighted loss function dynamically adjusts a weight of an aspect ratio consistency term during training.

17. A method comprising:
receiving an input image;
processing the input image through a classification branch and a regression branch, the classification branch and the regression branch each comprising an early stage and a late stage;
generating a first early feature map from the early stage of the classification branch;
generating a second early feature map from the early stage of the regression branch;
providing the first early feature map to the late stage of the regression branch;
providing the second early feature map to the late stage of the classification branch;
processing the first and second early feature maps to generate an output;
detecting an object based on the output; and
performing a function based on the detected object.

18. The method of claim 17, wherein the classification branch generates the early feature map of a first size, the regression branch generates the later feature map of a second size, and a concatenated feature map is a third size, and
wherein the first size, the second size, and the third size are different sizes.

19. The method of claim 17, further comprising performing a convolutional operation by applying a 1×1 convolution to reduce a size of a concatenated feature map.

20. The method of claim 17, wherein the function includes detecting the object within a bounding box on an edge device.
